(19) United States
(12) Patent Application Publication
(10) Pub. No.: US 2016/0380514 A1
(43) Pub. Date: Dec. 29, 2016

(54) BRUSHLESS ELECTRICAL MACHINE WITH AIR COOLING

(71) Applicant: ALMOTT LTD., Stara Zagora (BG)

(72) Inventor: Encho Nikolov POPOV, Sofia (BG)

(73) Assignee: Almott, Ltd., Stara Zagora (BG)

(21) Appl. No.: 14/898,174

(22) PCT Filed: Mar. 26, 2015
(86) PCT No.: PCT/BG2015/000007

§ 371 Date: Dec. 14, 2015

(30) Foreign Application Priority Data
Feb. 23, 2015 (BG) 111940

(51) Int. Cl. H02K 9/06; H02K 7/08; H02K 9/14; H02K 1/16; H02K 5/128; H02K 5/18; H02K 5/20; H02K 1/27

(52) U.S. Cl. CPC H02K 9/06; H02K 5/20; H02K 7/083; H02K 1/2706; H02K 1/16; H02K 5/128; H02K 5/18; H02K 9/14

(57) ABSTRACT

It is designed for operation as alternator and motor-alternator for mobile vehicles, as servomotor, as electric motor for electric cars and others. It has reduced overall dimensions in two mutually perpendicular directions while maintaining power. A part of the outer surface of the stator /5/ is smooth and is covered by aluminum body /8/ consisting of mirror located and pressed one to another fore-part /8a/ and rear part /8b/ of aluminum body /8/ with a section with square oval shape. In the corner zones of the aluminum body /8/ are formed axial ventilating ducts /9/. In case of need the rotor space is isolated from outside air by non-metallic cylindrical partition /23/.

### FIELD OF THE INVENTION

The present invention relates to brushless electrical machine with air cooling. It is designed for operation as servomotors, as electric motors for electric cars, as alternator for re-charging accumulator batteries and for producing of electric power with rectified voltage for mobile vehicles or immobile objects, as well as motor-alternators for mobile vehicles.

### PRIOR ART

An electrical machine as alternator is known [1] comprising drive shaft whereon stationary is fit up brushless rotor set with magnetomotive claw poles. The rotor set is enveloped by cylindrical stator. The cylindrical stator is put in cylindrical housing closed by front and rear end bells with vent-holes. On the driving shaft to the front end bell is mounted cooling fan. The drive shaft through front bearing and rear bearing is supported in front and rear end bells. The cylindrical stator consists of stator pack with multitude of slots even distributed on its inner surface. In the slots are laid one or more three phase windings. On the outer surface of the cylindrical stator are arranged a plurality regularly distributed vent ducts for passage of cooling air, which are closed externally by a cylindrical housing. Parallel ventilating ducts are also formed in the rotor space between the magnetic poles. On the rear end bell is attached a rectifying block.

Disadvantage of the known electrical machine is inefficient air cooling at increased overall dimensions in two mutually perpendicular directions due to the circular disposition and significant dimensions of the ventilating ducts formed on the outer surface of the cylindrical stator.

### SUMMARY OF THE INVENTION

The aim of the invention is to create electrical machine with air cooling with reduced overall dimensions in two mutually perpendicular directions while maintaining power.

This aim is solved by brushless electrical machine comprising drive shaft, supported through corresponding bearings in front and rear end bells, having stationary fit up on the drive shaft rotor set enveloped by cylindrical stator, whereon multitude of slots even distributed on its inner surface is formed, where one or more multiphase windings are laid with a number of phases more than two. The electrical machine is equipped with a fan and ventilating ducts. According to the invention, at least one third of the cylindrical stator is covered by aluminum body, centering on the outer surface of the cylindrical stator and is composed of fore-part, united with front end bell and mirror located to the fore-part rear part, which is united with the rear end bell. The covering aluminum body at least in its part comprising the cylindrical stator and partially outside it has four longitudinal walls, between which are arranged corner zones. Ventilating ducts are at least two and are formed in each corner zone of the two parts of the aluminum body, whereupon they are separated by partition internal ribs. The rear part is pressed against the fore-part so that the ducts and the partition internal ribs belonging to the fore-part and rear part of the aluminum body are an extension of one another.

The covering aluminum body is with a cross-section with square oval shape, and the four longitudinal walls are flat.

It is possible the covering aluminum body to be with cross-section square, and the four longitudinal walls to be flat.

It is possible that the four longitudinal walls of the aluminum body are parts of cylindrical surface with a radius exceeding repeatedly the radius of the corner zones.

It is possible to the rear end bell a cap to be fitted up with an inlet aperture for supply of cooling air from outside the working area of the brushless electric machine.

Over one or more of the flat walls of the front frame may be mounted distantly covers for deflection back and over the fore-part of the aluminum body part of coming out of the ventilation space cooling air.

On the outer surface of the stator, in the areas between every two adjacent partition internal ribs may be shaped grooves with a depth of not more than 15% of the thickness of the stator yoke and having a width no greater than half of the slot pitch on the inner surface of the stator.

In the space between the rotor set and the cylindrical stator may be mounted a non-metallic cylindrical partition aligned along the inner surface of stator.

It is recommended that the ends of the non-metallic cylindrical partition are connected in a sealing-off way, respectively to the front and rear end bells.

Air movement is carried out by own ventilator or fan with independent speed of rotation.

An advantage of the brushless electric machine according to the invention is the achieved effective air cooling at reduced overall dimensions in two mutually perpendicular directions while maintaining power.

Another advantage is the result of isolation from the outside air to the rotor space and protection of the permanent magnets against the thermal effects of stator through the non-metallic cylindrical partition.

### BRIEF DESCRIPTION OF THE DRAWINGS

FIG. 1 represents cross semi-sectional view of induction electric machine;

FIG. 2 represents longitudinal semi-sectional view through an air duct in the housing of brushless electrical machine with electromagnetic excitation comprising one rotor set with claw poles;

FIG. 3 represents longitudinal semi-sectional view through an air duct in the housing of brushless electrical machine with electromagnetic excitation comprising two mirror located rotor sets with claw poles;

FIG. 4 represents cross semi-sectional view of brushless electrical machine with permanent magnet excitation with isolated from the outside air rotor space;

FIG. 5 represents longitudinal semi-sectional view of brushless electrical machine with permanent magnet excitation with isolated from the outside air rotor space;

FIG. 6 represents cross partial section of sealed joint in brushless electrical machine with permanent magnet excitation in FIG. 5, which is realized between its end bells and the non-metallic cylindrical partition isolating the rotor space.

### DETAILED DESCRIPTION OF THE PREFERRED EMBODIMENTS

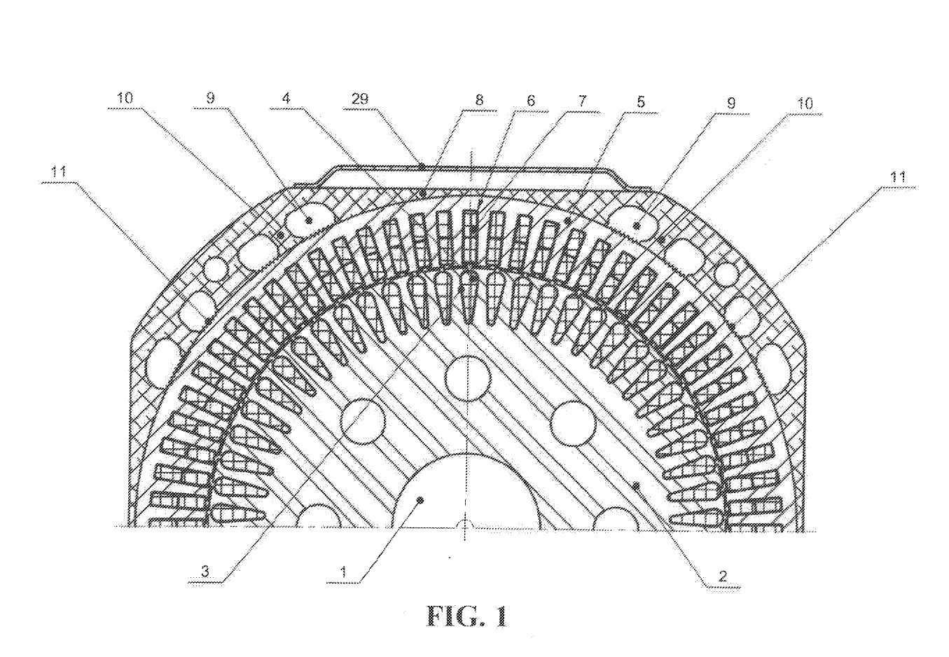

In an example embodiment of the invention shown on FIG. 1 the electrical machine according to the invention is realized as induction electrical machine. It consists of drive shaft 1, whereon stationary is fit up brushless rotor set 2. On the outer surface of the rotor set 2 is shaped a plurality of external slots 3, in each of them short-circuited winding 4 is laid. The rotor set 2 is enveloped by cylindrical stator 5. On the inner surface of the cylindrical stator 5 is formed multitude of even distributed slots 6, where are laid one or more windings 7 with number of phases more than two. At least one third of the length of the cylindrical stator 5 is covered by aluminum body 8 with a cross-section with square oval shape and having four flat walls, among which are arranged corner zones. The aluminum body 8 is composed of fore-part 8a and rear part 8b. The fore-part 8a is united with front end bell 16, supported through front bearing jointed to the drive shaft 1. The rear part 8b is united with rear end bell 13, supported through rear bearing jointed to the drive shaft 1. The rear part 8b is mirror located to the fore-part 8a and is pressed against it. In each corner zone of the aluminum body 8 with a section with square oval shape are formed at least two axial ventilating ducts 9. Between every two axial ventilating ducts 9 are formed internal partition ribs 10. As a variant of the invention on the outer surface of the stator 5, in the areas between every two adjacent partition internal ribs 10 of the aluminum body 8, are formed axial ventilation grooves 11 that are not deeper than 15% of the thickness of the stator yoke and wide no more than half of the pitch of the inner slots 6 arranged on the inner surface of the stator 5.

It is possible the covering aluminum body 8 to have a cross-section square.

Another possibility for the realization of the invention is the four longitudinal walls of the aluminum body 8 to be shaped as parts of a cylindrical surface which has a radius, repeatedly exceeding the radius of the corner zones.

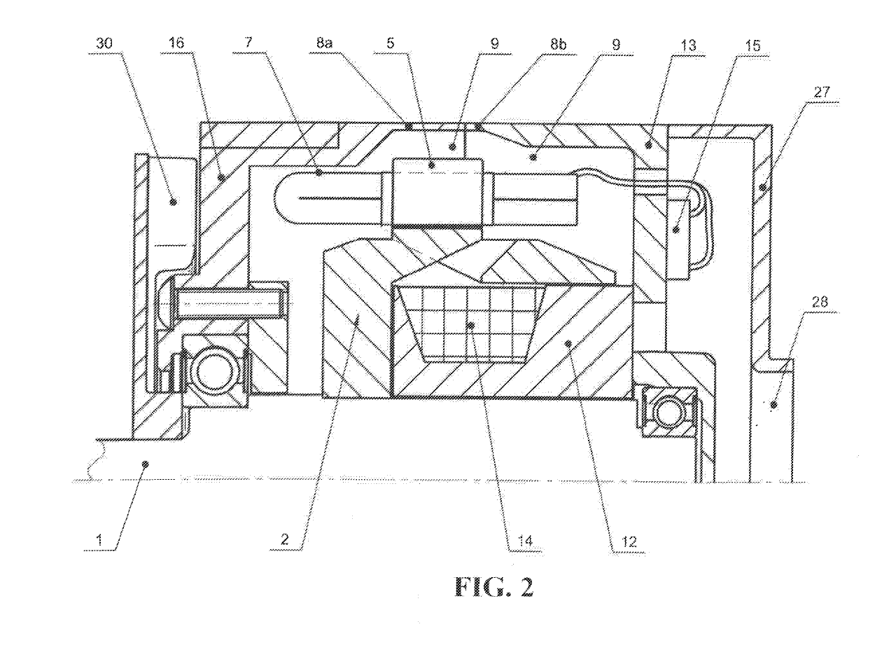

In the exemplary embodiment of FIG. 2 is a brushless electrical machine with electromagnetic excitation, comprising a rotor set with claw poles. On the drive shaft 1 is mounted a rotor set 2 with claw poles. The rotor set 2 is enveloped by cylindrical stator 5. On the inner surface of the stator 5 is formed multitude of even distributed internal slots 6, where are laid one or more windings 7 with number of phases more than two. The stator 5 is covered by aluminum body 8. The aluminum body 8 is composed of fore-pan 8a, united with the front end bell 16 and rear part 8b, united with rear end bell 13. At least in the area above a cylindrical stator 5 and partly outside it, the fore-pan 8a and the rear part 8b are with a cross-section with square oval shape. The aluminum body 8 has four flat walls, between which are arranged corner zones. In each corner zone of the aluminum body 8 with a section with square oval shape are formed at least two axial ventilating ducts 9 with internal partition ribs 10 there between. The rear part 8b of the body 8 is pressed to the fore-part 8a so that the ventilating ducts 9 and the partition internal ribs 10 in the rear part 8b are an extension of the ventilating ducts 9 and the internal partition ribs 10 in the fore-part 8a.

It is possible the covering aluminum body 8 to be realized with a cross-section square.

Another possibility for the realization of the invention is the four longitudinal walls of the aluminum body 8 to be shaped as parts of a cylindrical surface which has a radius, repeatedly exceeding the radius of the corner zones.

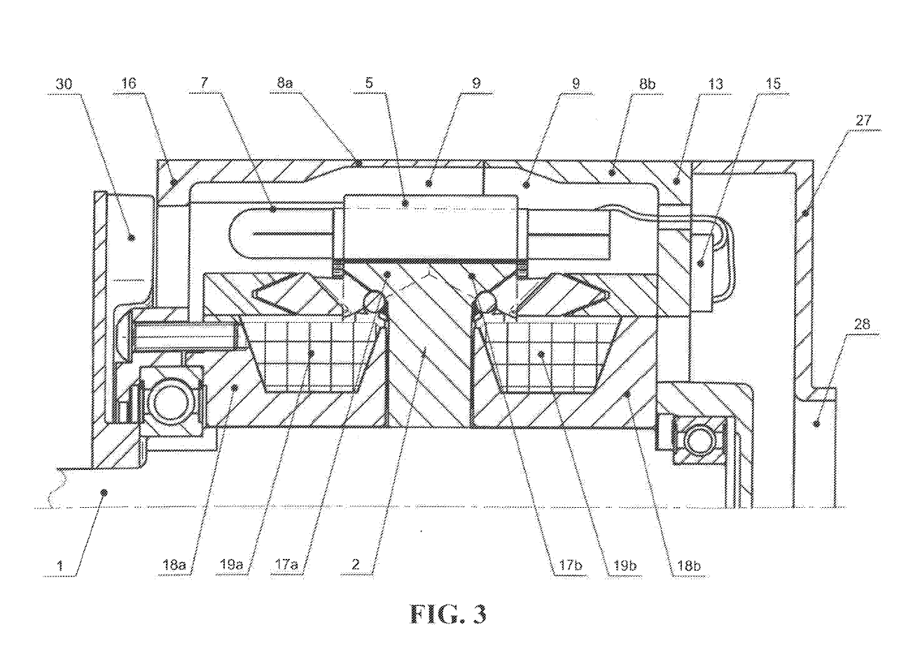

In another embodiment, shown in FIG. 3 the brushless electric machine is with electromagnetic excitation and comprises two mirror-located rotor sets with claw poles 17a and 17b, whereas the rotor set 2 is fit up on the drive shaft 1. The front rotor set with claw poles 17a comprises exciter 18a and the rear rotor set with claw poles 17b comprises exciter 18b. The front exciter 18a is fixed to the front end bell 16 and holds excitation coil 19a, and the rear exciter 18b is fixed to the rear end bell 13 and holds excitation coil 19b. The rotor set 2, constructed of two mirror located rotor sets with claw poles 17a and 17b, is covered by a cylindrical stator 5. On the inner surface of the cylindrical stator 5 is formed multitude of even distributed internal slots 6, where are laid one or more windings 7 with number of phases more than two. The stator 5 is covered by aluminum body 8. The aluminum body 8 is composed of fore-pan 8a united with the front end bell 16 and mirror located rear part 8b, united with rear end bell 13. At least in the area above the cylindrical stator 5 and partly outside it, the fore-part 8a and the rear part 8b are with a cross-section with square oval shape. The aluminum body 8 has four flat walls, between which are arranged corner zones. In each corner zone of the aluminum body 8 with a section with square oval shape are formed at least two axial ventilating ducts 9 with internal partition ribs 10 there between. The rear part 8b of the aluminum body 8 is pressed to the fore-part 8a so that the axial ventilating ducts 9 and the partition internal ribs 10 in the rear part 8b are an extension of the axial ventilation ducts 9 and the internal partition ribs 10 in the fore-part 8a.

It is possible the covering aluminum body 8 to be realized with cross-section square.

Another possibility for the realization of the invention is the four longitudinal walls of the aluminum body 8 to be shaped as parts of a cylindrical surface with a radius, repeatedly exceeding the radius of the corner zones.

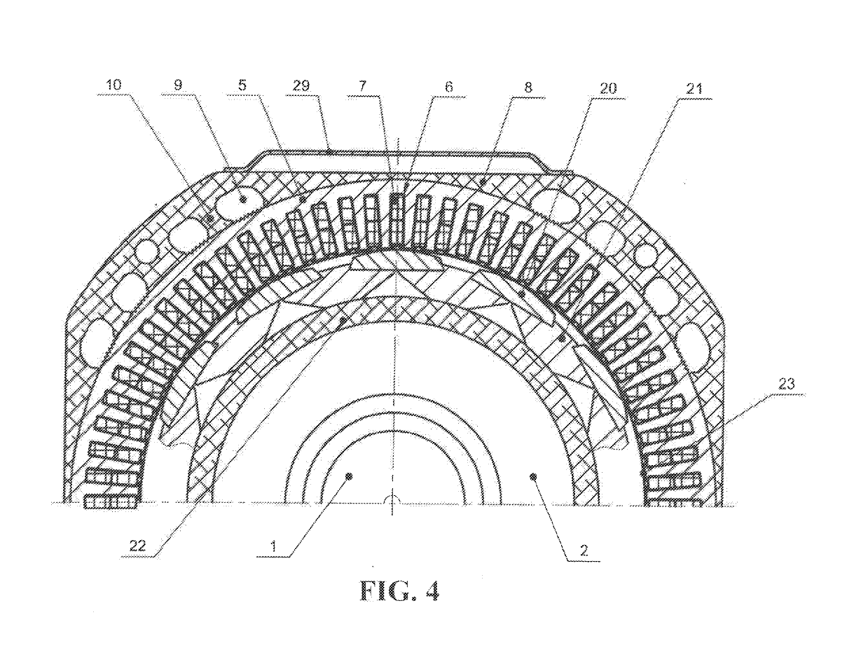

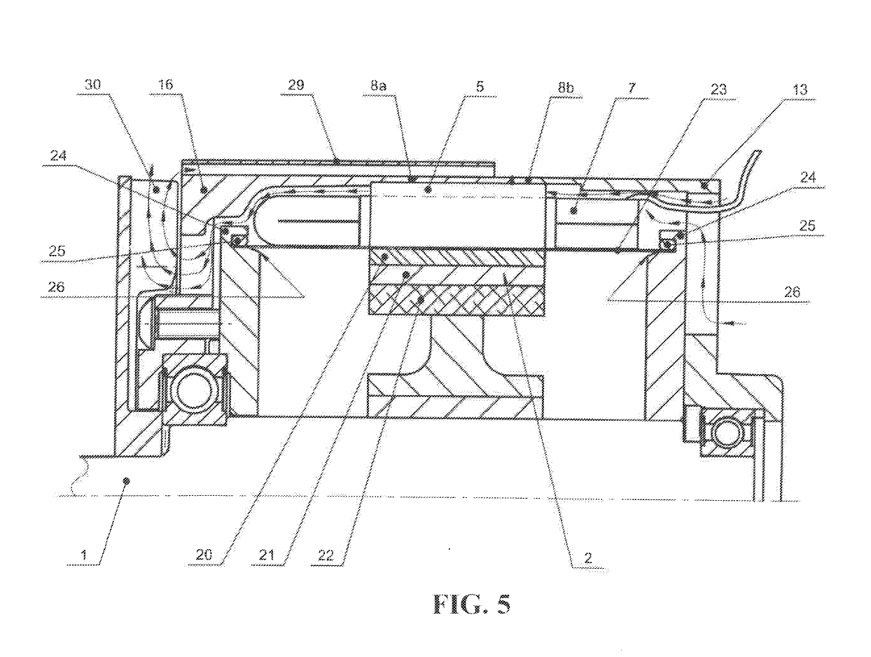

In the exemplary embodiment of FIG. 4 and FIG. 5 the brushless electrical machine is with permanent magnets. On the drive shaft 1 is fit up rotor set 2 containing permanent magnets 20 fasten on steel yoke 21 secured by carrier 22 to the drive shaft 1. The rotor set 2 is covered by a cylindrical stator 5. On the inner surface of the cylindrical stator 5 is formed multitude of even distributed internal slots 6, where are laid one or more windings 7 with number of phases more than two. At least one third of the length of the cylindrical stator 5 is covered by aluminum body 8. The aluminum body 8 is composed of fore-part 8a, united with front end bell 16 and mirror located rear part 8b, united with rear end bell 13. At least in the area above the cylindrical stator 5 and partly outside it, the fore-part 8a and the rear part 8b are with a cross-section with square oval shape. In each corner zone of the aluminum body 8 with a section with square oval shape are formed at least two axial ventilating ducts 9 with internal partition ribs 10 there between. The rear part 8b is pressed to the fore-part 8a so that the axial ventilating ducts 9 and the partition internal ribs 10 in the rear part 8b are an extension of the axial ventilating ducts 9 and the internal partition ribs 10 in the fore-part 8a. The rotor space around the rotor set 2 is isolated from the outside air by means of a non-metallic cylindrical partition 23 centered on the inner surface of the stator 5. The ends of the cylindrical partition 23 are connected in a sealing-off way, respectively to the front 16 and rear 17 end bells.

It is possible the covering aluminum body 8 to be realized with cross-section square.

Another possibility for the realization of the invention is the four longitudinal walls of the aluminum body 8 to be shaped as parts of a cylindrical surface which has a radius, repeatedly exceeding the radius of the corner zones.

When the brushless electrical machine with air cooling is used as an alternator the terminals of windings 7 of stator 5 are connected to rectifying block 15 and when it is used as motor-alternator the terminals of windings 7 of stator 5 are connected to power electronic control unit not shown on the figures.

Airflow in the brushless electrical machine is carried out by own ventilator mounted on the drive shaft of the electrical machine or by fan with independent speed of rotation, not shown on the figures.

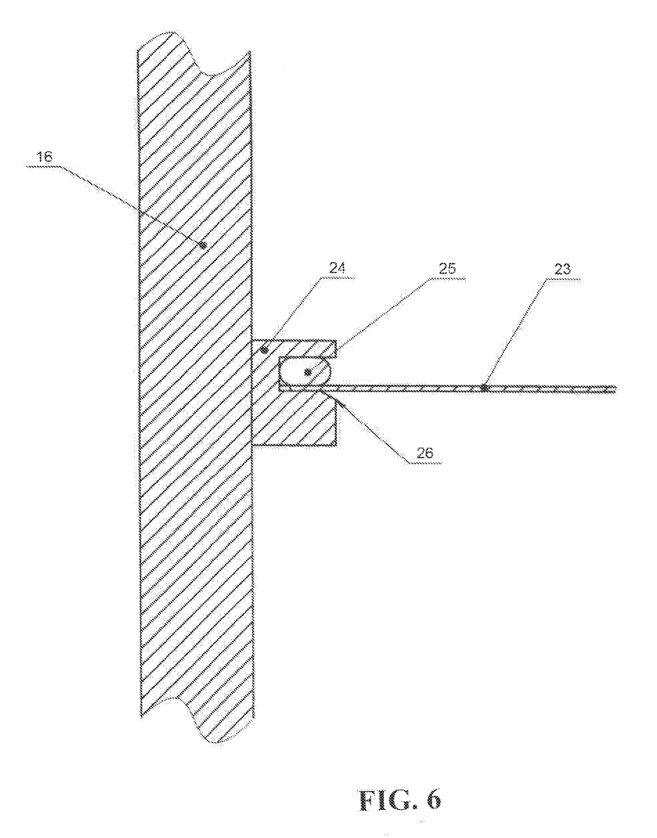

According to FIG. 6 each of the ends of non-metallic cylindrical partition 23 are shoved into directed to the rotor space frontal cylindrical grooves 24, fixed accordingly to front end bell 16 and rear end bell 13. In each of the grooves on the outer surface of the non-metallic cylindrical partition 23 is placed at least one elastic sealing ring 25. The elastic sealing rings 25 are pressed radially between the outer surfaces of the ends of the non-metallic cylindrical partition 23 and the outer surfaces in the frontal cylindrical grooves 24. The frontal cylindrical grooves 24 from the side of rotor space expand by passage of the cylindrical inner surfaces of the frontal cylindrical grooves 24 in the surface 26 in the shape of a truncated cone.

In a further embodiment of the invention, on the rear end bell 13 is fixed protecting cap 27 with inlet aperture 28 for supply of cooling air from outside heated zone around the brushless electrical machine.

In another embodiment of the invention above the one or more flat walls of the fore-part 8a of the aluminum body 8 and at a distance from it are fastened deviating covers 29 serving to divert back and over the fore-part 8a a part of the cooling air exiting from the ventilation space 30, which is connected with a fan, not shown on the figures, mounted before the front end bell 16.

Other embodiments of the invention are in the brushless electrical machine with electromagnetic excitation, containing one or two rotor sets with claw poles, as well as in a brushless electrical machine with permanent magnets excitation, wherein on the outer surface of the stator 5, in the region between the internal partition ribs 10 of the aluminum body 8 are formed axial ventilation grooves 11 which are not deeper than 15% of the thickness of stator yoke and wide no more than half of the pitch of the inner slots 6 arranged on the inner surface of the stator 5.

Operation of Brushless Electrical Machine with Air Cooling According to the Invention

In the brushless electrical machine with air cooling in the rotor and stator windings is separated heat loss. By the structure of the cooling system the housing is formed as a heat radiator removing heat from the stator. The passage of cooling air is concentrated in the corner zones by structuring in the corner zones of ventilating ducts 9 and radiator heat-consuming partition ribs 10. At the same time, united with the parts 8a and 8b end bells 13 and 16 extend radiator functions and help spreading the cooling air over a larger area of the frontal portions of the winding out of the stator. Thus, the cooling capacity of the brushless electrical machine with structured system for air cooling is approximated in efficacy to cooling power of the system with cooling, realized by liquid passing in a separate radiator, at that the dimensions are reduced. In brushless electrical machine with permanent magnet excitation, through the non-metallic cylindrical partition 23, permanent magnets 20 are protected against contamination atmospheric impact at the implemented intensive cooling of the stator 5, at the same time, the heat transfer from the stator 5 to the permanent magnets 20 is reduced.

Experimental Results Received by Sample Investigation Realising the Invention

According to the invention is created a virtual model of a motor-alternator with permanent magnet excitation with continuous power 5 KVA, maximum power 10 KVA, maximum torque 60 Nm. The battery voltage is 48 V, and maximum current at startup is 300 A. Side of the section with square oval shape is 150 mm, length with built-in power electronic control unit is 360 mm. The model is fit to work with maximum temperature rise of the winding 130° C., which is comparable to competitive model with similar parameters, and liquid cooling.

Established performance of the virtual model with permanent magnets: maximum rise of the temperature of the suitor winding 142° C., maximum torque 180 Nm, maximum power 60 kW, rated power 20 KW for battery 48V, maximum current at startup as motor-alternator 600 A, side of the section with square oval shape 185 mm, length of the sample with built-in power electronic block 400 mm.

### REFERENCES

1. U.S. Pat. No. 7,915,783

1. Brushless electrical machine comprising drive shaft supported through corresponding bearings in front and rear end bells, having stationary fit up on the drive shaft rotor set, enveloped by cylindrical stator, on its inner surface is even distributed multitude of slots, where are laid one or more multiphase windings with a number of phases more than two, whereas the brushless electrical machine is provided with a fan and ventilating ducts, characterized by that at least one third of said cylindrical stator /5/ is covered by aluminum body /8/, centering on the outer surface of said cylindrical stator /5/, composed of fore-part /8a/, united with said front end bell /16/ and mirror located to said fore-part /8a/ rear part /8b/, which is united with said rear end bell /13/, whereas said covering aluminum body /8/ at least in the part covering said cylindrical stator /5/ and partially outside it has four longitudinal walls, among which are arranged corner zones, whereas ventilating ducts /9/ are at least two and are formed in each corner zone of the two parts /8a and 8b/ of said aluminum body /8/, separated by a partition internal ribs /10/, whereas said rear part /8b/ is pressed to said fore-part /8a/ so that said ducts /9/ and said partition internal ribs /10/ belonging to said fore-part /8a/ and to said rear part /8b/ of said aluminum body /8/ are an extension for one another.

2. Brushless electrical machine according to claim 1, wherein said covering aluminum body /8/ is with a cross-section with square oval shape and its four longitudinal walls are flat.

3. Brushless electrical machine according to claim 1, wherein said covering aluminum body /8/ is with a cross-section square and its four longitudinal walls are flat.

4. Brushless electrical machine according to claim 1, wherein said four longitudinal walls of said aluminum body /8/ are parts of a cylindrical surface with a radius, repeatedly exceeding the radius of the corner zones.

5. Brushless electrical machine according to claims 1 to 4, wherein on said rear end bell /13/ is fixed protecting cap /27/ with inlet aperture /28/ for supply of cooling air from outside the working area of the brushless electrical machine.

6. Brushless electrical machine according to claims 1 to 4, wherein over one or more of said flat walls of said fore-part /8a/ at a distance are fastened deviating covers /29/ for diverting back and over said fore-part /8a/ a part of the exiting from the ventilator cooling air.

7. Brushless electrical machine according to claims 1 to 4, wherein on the outer surface of said stator /5/, in the areas between every two said adjacent partition internal ribs /10/ are formed grooves /11/ with depth not greater than 15% of the thickness of the stator yoke and with width no more than half of the slot pitch on the inner surface of the stator /5/.

8. Brushless electrical machine according to claims 1 to 4, wherein in the space between said rotor set /2/ and said cylindrical stator /5/ is mounted a non-metallic cylindrical partition /23/, centered on the inner surface of said stator /5/.

9. Brushless electrical machine according to claim 8, wherein the ends of said cylindrical partition /23/ are connected in a sealing-off way, respectively to the front /16/ and rear /17/ end bells.
